(19) United States
(12) Patent Application Publication
(10) Pub. No.: US 2026/0145682 A1
(43) Pub. Date: May 28, 2026

(54) FRICTION COEFFICIENT ESTIMATION DEVICE AND FRICTION COEFFICIENT ESTIMATION METHOD

(71) Applicants: DENSO CORPORATION, Kariya-city (JP); J-QuAD DYNAMICS Inc., Tokyo (JP); JTEKT CORPORATION, Kariya-shi (JP); ADVICS CO., LTD., Kariya-shi (JP); AISIN CORPORATION, Kariya (JP)

(72) Inventors: Nobuhiro NITTA, Tokyo (JP); Takashi ASAI, Tokyo (JP)

(21) Appl. No.: 19/400,790

(22) Filed: Nov. 25, 2025

(30) Foreign Application Priority Data
Nov. 28, 2024 (JP) 2024-207624

(51) Int. Cl. B60W 40/068; B60C 23/06

(52) U.S. Cl. CPC B60W 40/068; B60C 23/06; B60W 2552/35; B60W 2552/40

(57) ABSTRACT

A friction coefficient estimation device for a vehicle includes at least one of a processor or a circuit configured to: acquire environment information of the vehicle; identify tire characteristic of the vehicle based on a detection result of at least one of a vehicle motion sensor or a tire sensor; identify road surface characteristic around the vehicle based on the environment information; store a tire model that outputs a friction coefficient between a road surface and a tire according to a combination of the road surface characteristic and the tire characteristic; and estimate the friction coefficient around the vehicle using the tire characteristic, the road surface characteristic and the tire model.

### CROSS REFERENCE TO RELATED APPLICATION

This application is based on Japanese Patent Application No. 2024-207624 filed on Nov. 28, 2024, the disclosure of which is incorporated herein by reference.

### TECHNICAL FIELD

The present disclosure relates to a friction coefficient estimation device and a friction coefficient estimation method.

### BACKGROUND

Techniques for estimating a coefficient of friction between a vehicle tire and a road surface are known.

### SUMMARY

According to an aspect of the present disclosure, a friction coefficient estimation device, for a vehicle, includes at least one of (i) a circuit and (ii) a processor with a memory storing computer program code executable by the processor, the at least one of the circuit and the processor configured to cause the friction coefficient estimation device to:
acquire environment information about an environment of the vehicle;
identify tire characteristic of a tire of the vehicle based on a detection result of at least one of (i) a vehicle motion sensor to detect states related to behavior or operation correlated with a tire force of the vehicle and (ii) a tire sensor to monitor the tire of the vehicle;
identify road surface characteristic of a road surface around the vehicle based on the environment information;
store a tire model that outputs a friction coefficient between the road surface and the tire according to a combination of the road surface characteristic and the tire characteristic; and
estimate the friction coefficient around the vehicle using the tire characteristic, the road surface characteristic and the tire model.

### BRIEF DESCRIPTION OF DRAWINGS

FIG. 1 is a diagram showing a schematic configuration of a system for a vehicle.

FIG. 2 is a diagram showing a schematic configuration of a friction coefficient estimation device.

FIG. 3 is a diagram for explaining an example of a map-like tire model.

FIG. 4 is a flowchart showing a flow of processing related to estimation of friction coefficient in the friction coefficient estimation device.

FIG. 5 is a flowchart showing a flow of processing related to correction of model in the friction coefficient estimation device.

### DETAILED DESCRIPTION

Techniques for estimating a coefficient of friction between a vehicle tire and a road surface are known. For example, there is a technique for primarily identifying a first range of friction coefficient corresponding to road surface conditions based on friction coefficient information that is divided in advance for each road surface condition and the road surface condition. There is a technique for selecting parameter values corresponding to the rubber friction force, snow column shear force, and edge effect between the vehicle tire and the road surface, and then narrows the first range to a narrower second range to secondarily identify the friction coefficient.

However, when the friction coefficient is secondarily identified, difference in the type of tire, individual differences among the tires, and degrees of deterioration on each vehicle are not taken into consideration. Therefore, the accuracy of estimating the friction coefficient may be degraded depending on the tires.

The present disclosure provides a friction coefficient estimation device and a friction coefficient estimation method to enable more accurate estimation of friction coefficient of a vehicle even when there are differences in tires between vehicles.

According to a first aspect of the present disclosure, a friction coefficient estimation device for a vehicle includes:
an environment information acquisition unit configured to acquire environment information about a surrounding environment of the vehicle;
a tire characteristic identification unit configured to identify tire characteristics of a tire of the vehicle, based on a detection result of at least one of a vehicle motion sensor to detect various states related to behavior or operation correlated with a tire force of the vehicle and a tire sensor to monitor the tire of the vehicle;
a road surface characteristic identification unit configured to identify road surface characteristics of a road surface around the vehicle, based on the environment information acquired by the environment information acquisition unit;
a model storage unit configured to hold a tire model that outputs a friction coefficient between a road surface and a tire according to a combination of the road surface characteristics and the tire characteristics; and
a friction coefficient estimation unit configured to estimate the friction coefficient around the vehicle using the tire characteristics identified by the tire characteristic identification unit, the road surface characteristics identified by the road surface characteristic identification unit and the tire model held in the model storage unit.

According to a second aspect of the present disclosure, a friction coefficient estimation method executed by at least one of a processor or a circuit for a vehicle includes:
an environment information acquisition step to acquire environment information about a surrounding environment of the vehicle;
a tire characteristic identification step to identify tire characteristics of a tire of the vehicle, based on a detection result of at least one of a vehicle motion sensor to detect various states related to behavior or operation correlated with a tire force of the vehicle and a tire sensor to monitor the tire of the vehicle;
a road surface characteristic identification step to identify road surface characteristics of a road surface around the vehicle, based on the environment information acquired in the environment information acquisition step; and
a friction coefficient estimation step to estimate a friction coefficient around the vehicle using the tire characteristics identified in the tire characteristic identification step, the road surface characteristics identified in the road surface characteristic identification step, and a tire model held in a model storage unit to output a friction coefficient between a road surface and a tire according to a combination of the road surface characteristics and the tire characteristics.

Accordingly, the friction coefficient is estimated using the road surface characteristics identified based on the environment information, the tire characteristics, and the tire model that outputs the friction coefficient between the road surface and the tire according to the combination of the road surface characteristics and tire characteristics, so that the friction coefficient can be estimated according to the road surface characteristics and the tire characteristics. Furthermore, since the tire characteristics are identified based on the detection result of at least one of the vehicle motion sensor and the tire sensor, it becomes possible to estimate the friction coefficient according to the tire characteristics in response to the tire of the individual vehicle. As a result, it becomes possible to estimate the coefficient of friction of the vehicle with higher accuracy even when there are differences in the tires of vehicles.

Several embodiments for disclosure will be described with reference to the drawings. For convenience of explanation, portions having the same functions as those illustrated in the drawings used in the description among embodiments are assigned the same reference symbol, and descriptions of the same portions may be omitted. The descriptions of other embodiments may be referred to with respect to these portions given the same reference signs.

### First Embodiment

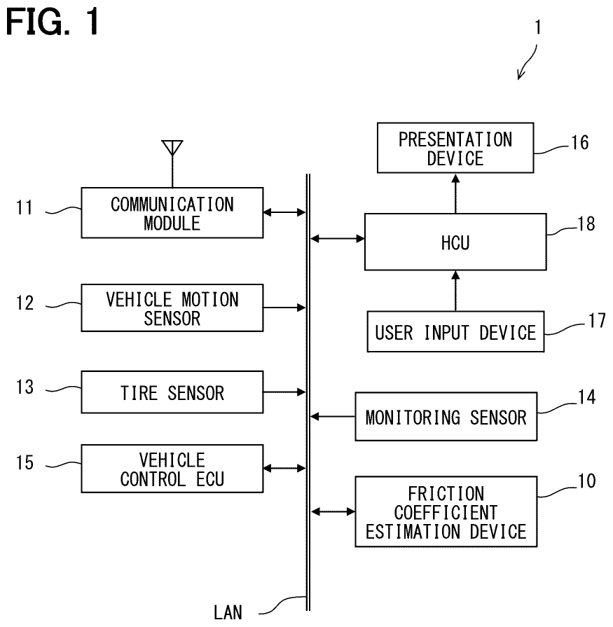

Hereinafter, a first embodiment of the present disclosure will be described with reference to the drawings. A system 1 shown in FIG. 1 is used for a vehicle. As shown in FIG. 1, the system 1 includes a friction coefficient estimation device 10, a communication module 11, a vehicle motion sensor 12, a tire sensor 13, a monitoring sensor 14, a vehicle control ECU 15, a presentation device 16, a user input device 17, and an HCU (Human Machine Interface Control Unit) 18. For example, the friction coefficient estimation device 10, the communication module 11, the vehicle motion sensor 12, the tire sensor 13, the monitoring sensor 14, the vehicle control ECU 15, and the HCU 18 may be connected to an in-vehicle LAN (see LAN in FIG. 1). Although the vehicle including the system 1 is not necessarily limited to an automobile, a case where the system 1 is used in an automobile will be described below as an example.

The communication module 11 transmits and receives information to and from devices external to the vehicle via wireless communication. The communication module 11 may receive information about the road surface (hereinafter referred to as road surface information) transmitted from outside the vehicle. The road surface information may be related to the state of the road surface (hereinafter referred to as the road surface state) such as “ICE”, “SNOW”, “WET”, “DRY” and the like. “ICE” indicates that the road surface is frozen. “SNOW” means that snow has accumulated on the road surface. “WET” indicates that the road surface is wet. “DRY” indicates that the road surface is dry. The road surface information may include road surface conditions such as roughness of the road surface. The communication module 11 may receive road surface information transmitted from the center via wide-area communication. The communication module 11 may receive road surface information about an area around the vehicle by transmitting the vehicle's position measured by the vehicle's locator to the center. The communication module 11 may receive road surface information about an area around a roadside device transmitted from the roadside device through road-to-vehicle communication. The road surface information received from the roadside device corresponds to road surface information about the area around the vehicle.

The vehicle motion sensor 12 represents a group of sensors for detecting various states related to behavior or operation of the vehicle, correlated with a tire force. The tire force refers to a force acting on the contact surface of the tire in contact with the ground. The various states include, for example, the steering angle, steering torque, brake operation amount, brake drive amount, power train operation amount, and power train drive amount. The other examples include the wheel speed, vehicle speed, wheel speed slip ratio, yaw rate, front-rear acceleration, lateral acceleration, and the like. The steering angle can be detected by a steering angle sensor. The steering torque may be detected by a steering torque sensor. The brake operation amount may be detected by a brake pedal position sensor. The brake drive amount may be, for example, an indicated braking force. The indicated braking force may be detected by a brake ECU. The power train operation amount may be detected by an accelerator position sensor. The power train drive amount may be detected by a power unit control ECU. The wheel speed may be detected by a wheel speed sensor. The vehicle speed and the wheel slip ratio may be detected by an ECU that calculates them. The vehicle speed may be calculated based on the wheel speed of tire. The wheel slip ratio may be calculated from the vehicle speed and the wheel speed. The yaw rate can be detected by a yaw rate sensor. The front-rear acceleration and the lateral acceleration may be detected by an acceleration sensor. The vehicle motion sensor 12 outputs the detected sensing information to the in-vehicle LAN. The sensing information detected by the vehicle motion sensor 12 may be output to the in-vehicle LAN via ECU mounted in the vehicle.

The tire sensor 13 detects the air pressure, temperature, load, etc. of the tire of the vehicle. That is, the tire sensor 13 monitors the tire. The tire sensor 13 may have, for example, a sensor body attached to the inner surface of the tire and a detection result from the sensor body is acquired by radio waves using an antenna. To determine the air pressure, the load can be detected from the results of measuring the strain that occurs when the tire is in contact with the road surface. The tire sensor 13 outputs the detected sensing information to the in-vehicle LAN.

The monitoring sensor 14 monitors a surrounding environment of the vehicle. The monitoring sensor 14 measures road surface information around the vehicle at a position different from the position where the vehicle's tire is placed. For example, the monitoring sensor 14 may be a periphery monitoring camera that captures an image of a predetermined range around the vehicle. For example, the monitoring sensor 14 may be a search wave sensor that transmits search waves within a predetermined range around the vehicle. Examples of the search wave sensor include millimeter wave radar, and LIDAR (Light Detection and Ranging/Laser Imaging Detection and Ranging). For example, the monitoring sensor 14 may be a thermosensor that measures the temperature within a predetermined range around the vehicle. For example, an infrared sensor capable of measuring temperature without contact may be used as the thermosensor. The predetermined range may include at least part of the front, rear, left and right sides of the vehicle. The predetermined range may include the area ahead of the vehicle. The predetermined range may include the area behind the vehicle. The periphery monitoring camera sequentially outputs the captured images as sensing information to the in-vehicle LAN. The search wave sensor sequentially outputs the scanning results, based on the received signals when receiving the waves reflected by the road surface or the like, to the in-vehicle LAN as sensing information. The thermosensor sequentially outputs the results of measuring the road surface temperature as sensing information to the in-vehicle LAN.

The vehicle control ECU 15 is an electronic control unit that controls traveling of the vehicle, such as an acceleration/deceleration control and/or a steering control. The vehicle control ECU 15 includes a steering ECU to control the steering, and a power unit control ECU and a brake ECU to control the acceleration/deceleration. The vehicle control ECU 15 executes the driving control by outputting control signals to each driving control device mounted on the vehicle. Examples of the driving control device include an electronic control throttle, a brake actuator, and an EPS (i.e., Electric Power Steering) motor.

The presentation device 16 presents information to the interior of the vehicle. The presentation device 16 includes, for example, a display device and an audio output device. The display device presents information by displaying the information. The display device executes display in accordance with an instruction from the HCU 18. The display device may be a meter MID (Multi Information Display), CID (Center Information Display), or HUD (Head-Up Display).

The meter MID is a display device located in front of a driver seat in a cabin. For example, the meter MID may be provided in a meter panel. The CID is a display device disposed at a center of an instrument panel of the vehicle. The HUD is provided, for example, on an instrument panel in a cabin of the vehicle. The HUD projects a display image formed by a projector onto a predetermined projection area of the front windshield, which serves as a projection member. Light from the image reflected toward the vehicle interior by the front windshield is perceived by the driver seated in the driver seat. As a result, the driver can visually recognize the virtual image of the display image, which is formed in front of the front windshield, superimposed on part of the foreground. The HUD may be configured to project the display image onto a combiner provided in front of the driver seat, instead of the front windshield.

The audio output device presents information by outputting audio. The audio output device outputs audio according to instructions from the HCU 18. Examples of the audio output device include a speaker provided in the cabin of the vehicle.

The user input device 17 accepts input from the user. The user input device 17 may be an operation device that receives operation inputs from the user. The operation device may be a mechanical switch or a touch switch integrated with the display. The user input device 17 is not limited to the operation device that accepts the operation input while accepting input from the user. For example, the user input device 17 may be an audio input device that receives command input by an audio such as voice from the user.

The HCU 18 mainly includes a computer having a processor, a volatile memory, a nonvolatile memory, an I/O, and a bus connecting them. The HCU 18 is connected to the presentation device 16 and the user input device 17. The HCU 18 executes various processing related to interaction between an occupant and a system of the vehicle by executing a control program stored in the nonvolatile memory. The HCU 18 controls the presentation of information by the presentation device 16. The HCU 18 may have a circuit that performs at least some of the functions performed by a processor. The term “circuit” as used here refers to hardware circuits.

The friction coefficient estimation device 10 is mainly composed of a computer including, for example, a processor, a volatile memory, a non-volatile memory, an I/O, and a bus connecting them. The friction coefficient estimation device 10 executes a control program stored in a non-volatile memory to perform processing related to estimation of the friction coefficient between the tire of the vehicle and the road surface. In addition, in the friction coefficient estimation device 10, at least some of the functions performed by the processor may be performed by a circuit. The term “circuit” as used here refers to hardware circuits. The configuration of the friction coefficient estimation device 10 will be described in detail below.

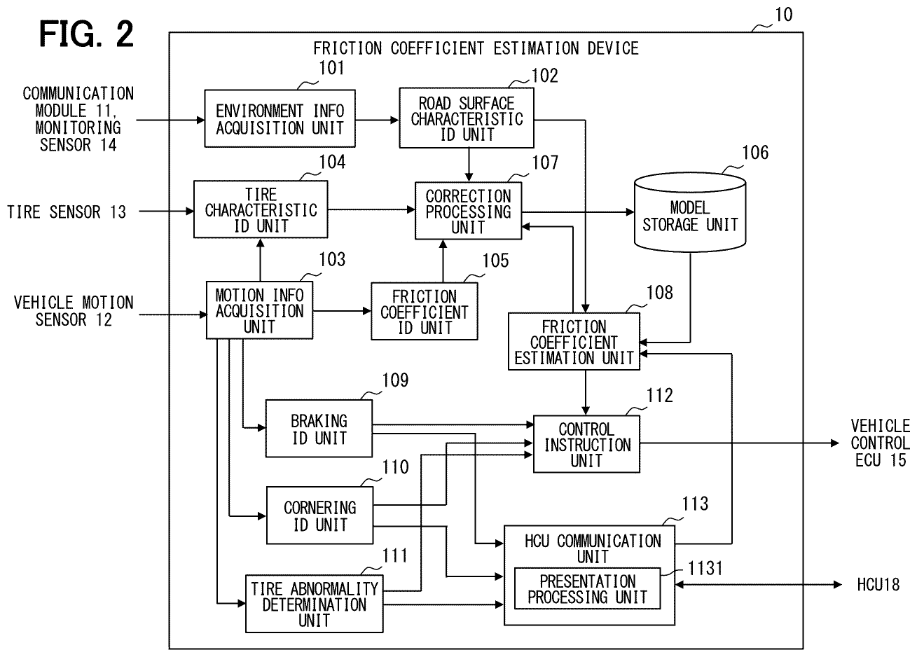

The schematic configuration of the friction coefficient estimation device 10 will be described with reference to FIG. 2. As shown in FIG. 2, the friction coefficient estimation device 10 includes, as functional blocks, an environment information acquisition unit 101, a road surface characteristic identification unit 102, a motion information acquisition unit 103, a tire characteristic identification unit 104, a friction coefficient identification unit 105, a model storage unit 106, a correction processing unit 107, a friction coefficient estimation unit 108, a braking identification unit 109, a cornering identification unit 110, a tire abnormality determination unit 111, a control instruction unit 112, and an HCU communication unit 113. Furthermore, the execution of the processing of each functional block of the friction coefficient estimation device 10 by a computer corresponds to the execution of a friction coefficient estimation method. Some or all of the functions executed by the friction coefficient estimation device 10 may be configured as hardware using one or more circuits or the like. Furthermore, some or all of the functional blocks of the friction coefficient estimation device 10 may be realized by a combination of software executed by a processor and hardware circuits.

The environment information acquisition unit 101 acquires environment information about the surrounding environment of the vehicle. The environment information acquisition unit 101 may acquire sensing information of the road surface around the vehicle output from the monitoring sensor 14 as environment information. The monitoring sensor 14 from which the environment information acquisition unit 101 acquires sensing information may be one type or a combination of multiple types. The environment information acquisition unit 101 may acquire road surface information received by the communication module 11 as environment information. The processing in the environment information acquisition unit 101 corresponds to an environment information acquisition step.

The road surface characteristic identification unit 102 identifies road surface characteristics of the road surface around the vehicle, based on the environment information acquired by the environment information acquisition unit 101. The road surface characteristics include road surface conditions such as “ICE”, “SNOW”, “WET” and “DRY”. The road surface characteristics may be classified into categories such as “ICE”, “SNOW”, “WET” and “DRY”, as well as into more detailed road surface conditions such as roughness of the road surface. The road surface characteristics may be referred to as road surface conditions. The road surface characteristic identification unit 102 may estimate the road surface condition based on the sensing information from the monitoring sensor 14, thereby identifying the road surface characteristics. For example, a learning device that has machine-learned the correlation between the sensing information from the monitoring sensor 14 and the road surface condition may be used to estimate the road surface condition based on the sensing information. The road surface characteristic identification unit 102 may use sensing information from multiple types of sensors when it is difficult to accurately estimate the road surface condition using sensing information from only one type of sensor. When the road surface information received by the communication module 11 can be acquired by the environment information acquisition unit 101, the road surface characteristic identification unit 102 may do the following. The road surface characteristic identification unit 102 may identify the road surface condition indicated by the road surface information as the road surface characteristic. The processing in the road surface characteristic identification unit 102 corresponds to a road surface characteristic identification step.

The motion information acquisition unit 103 acquires sensing information output from the vehicle motion sensor 12. The tire characteristic identification unit 104 identifies the tire characteristics of the tire of the vehicle, based on the detection results of at least one of the vehicle motion sensor 12 or the tire sensor 13. The tire characteristics include the tire air pressure, temperature, load, type, degree of deterioration, and state of wear. The type includes the tire manufacturer, model number, and whether the tire is a summer tire or a winter tire.

The tire characteristic identification unit 104 may specify the tire characteristics such as tire air pressure, temperature, and load as the tire characteristics based on the results detected by the tire sensor 13. The tire characteristic identification unit 104 may specify the type of tire, the degree of deterioration, the state of wear, etc. from the sensing information output from the vehicle motion sensor 12. The details will be described as follows. The tire characteristics affect the behavior of the vehicle. Therefore, there is a correlation between the behavior of the vehicle in response to operation and the tire characteristics. By utilizing this, for example, a learning device that has machine-learned the correlation between the behavior of the vehicle in response to operation and tire characteristics can be used to identify tire characteristics from the state of behavior in response to operation of the vehicle. The processing in the motion information acquisition unit 103 corresponds to a tire characteristic identification step. The tire characteristic identification unit 104 may identify the tire characteristics of each tire of the vehicle. The tire characteristic identification unit 104 preferably identifies the tire characteristics based on at least the detection results of the vehicle motion sensor 12. This makes it possible to identify tire characteristics that are difficult to detect with the tire sensor 13.

The friction coefficient identification unit 105 specifies the friction coefficient between the tire of the vehicle and the road surface based on the detection result of the vehicle motion sensor 12. The behavior of vehicle in response to operation is correlated with the friction coefficient. Therefore, the friction coefficient identification unit 105 may specify the friction coefficient using an existing method, for example, based on the correlation between the behavior of the vehicle in response to the operation and the friction coefficient. The friction coefficient determined based on the detection results of the vehicle motion sensor 12 can accurately determine the friction coefficient that actually occurs between the tire of the vehicle and the road surface. However, the friction coefficient determined by the friction coefficient identification unit 105 is a friction coefficient for the current position, and does not determine the friction coefficient in the surrounding area that may be on the path of the vehicle. The friction coefficient estimation unit 108, which will be described later, estimates the friction coefficient around the vehicle. The friction coefficient identification unit 105 may identify the friction coefficient for each tire of the vehicle. The friction coefficient identification unit 105 may identify the average value of the friction coefficients of the tires as the friction coefficient of the tire of the vehicle.

The result of the road surface characteristic determination performed by the road surface characteristic identification unit 102 may be corrected based on the friction coefficient determined by the friction coefficient identification unit 105. The range of possible friction coefficients varies depending on the road surface characteristics. Therefore, when the road surface characteristics are difficult to distinguish and identify by the road surface characteristic identification unit 102, the road surface characteristics can be narrowed down and identified again from the friction coefficient, when errors are estimated from the friction coefficient. For example, the road surface characteristic identification unit 102 is likely to mistakenly specify black ice as “ICE” instead of “DRY.” On the other hand, by using the coefficient of friction, it is easy to distinguish whether the road surface characteristics are “ICE” or “DRY.” As an example, when the friction coefficient is in a range that cannot be taken by “ICE” out of “ICE” and “DRY,” but the road surface characteristic identification unit 102 identifies it as “ICE,” the road surface characteristic can be corrected to “DRY.”

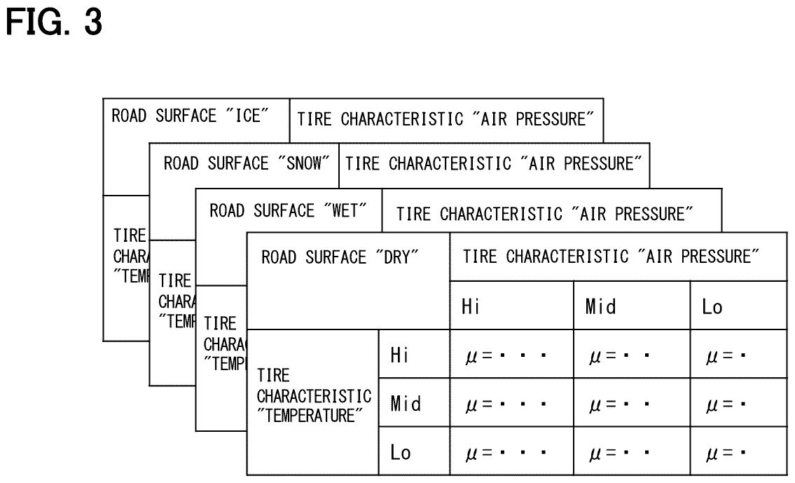

The model storage unit 106 stores the tire model. That is, the model storage unit 106 holds the tire model. The model storage unit 106 corresponds to a model holding unit. The model storage unit 106 may be, for example, a nonvolatile memory. The tire model is set for outputting a coefficient of friction between a road surface and a tire according to a combination of the road surface characteristics and the tire characteristics. The tire model may be stored in the model storage unit 106 in advance, or may be constructed sequentially while learning during driving. The pre-stored tire model may be obtained from data obtained from a bench test machine or a running test. The tire model may be a dynamic model such as the Magic Formula model obtained by scaling tire characteristics on “DRY” road surface. In this embodiment, as shown in FIG. 3, the tire model includes a map in which combinations of the road surface characteristics and the tire characteristics are associated with the friction coefficients corresponding to the combinations.

An example of the map-like tire model will be described with reference to FIG. 3. In FIG. 3, the coefficient of friction is represented by μ. In FIG. 3, for the sake of simplicity, the tire characteristics “air pressure” and “temperature” will be used as examples. In FIG. 3, for the sake of simplicity, the road surface characteristics “ICE”, “SNOW”, “WET”, and “DRY” will be used as examples. In FIG. 3, the tire characteristics will be described as being divided into three levels, “Hi”, “Mid”, and “Lo”, depending on the magnitude of the numerical value. As shown in FIG. 3, the tire model is associated with a value of the friction coefficient μ according to a combination of road surface characteristics and tire characteristics. For example, a friction coefficient μ is associated with each combination of road surface characteristic and tire characteristic classified by the magnitude of the numerical value. In FIG. 3, the road surface characteristics “ICE”, “SNOW”, “WET”, and “DRY” are given as examples, but other combinations of road surface characteristics may be included in the tire model. In FIG. 3, the tire characteristics “air pressure” and “temperature” are taken as examples, but other combinations of tire characteristics may be included in the tire model. For example, tire characteristics such as “load,” “type,” “degree of deterioration,” and “state of wear” may be included. Additionally, a combination of three or more tire characteristics may be included in the tire model.

The correction processing unit 107 preferably corrects the tire model stored in the model storage unit 106 using the tire characteristics identified by the tire characteristic identification unit 104. This makes it possible to correct the tire model to match the current tire characteristics of the vehicle. For example, the correction processing unit 107 may perform the correction to update the tire model stored in the model storage unit 106 using the tire characteristics identified by the tire characteristic identification unit 104 and the friction coefficient identified by the friction coefficient identification unit 105. When a tire model is stored in advance in the model storage unit 106, the following procedure may be performed, for example. First, the correction processing unit 107 compares the friction coefficient corresponding to the tire characteristics identified by the tire characteristic identification unit 104 in the tire model with the friction coefficient identified by the friction coefficient identification unit 105. When the deviation between these values is equal to or greater than a threshold value, the friction coefficient of the tire model may be corrected by replacing it with the friction coefficient identified by the friction coefficient identification unit 105. When the tire model is not stored in advance in the model storage unit 106, the following procedure may be taken, for example. The correction processing unit 107 may perform correction by adding the friction coefficient identified by the friction coefficient identification unit 105 to the tire model as a friction coefficient according to the tire characteristics identified by the tire characteristic identification unit 104 and updating the tire model. This process corresponds to the learning of the tire model described above. In these cases, the corresponding road surface characteristics can be roughly estimated from the friction coefficient identified by the friction coefficient identification unit 105. Specifically, it is sufficient to roughly estimate the coefficient of friction from the range that can be assumed for each road surface characteristic. In addition, it is preferable to use the corresponding road surface characteristics identified by the road surface characteristic identification unit 102, as will be described later.

The correction processing unit 107 preferably corrects the tire model stored in the model storage unit 106 using the tire characteristics identified by the tire characteristic identification unit 104 for each road surface characteristic identified by the road surface characteristic identification unit 102. This makes it possible to identify road surface characteristics with high accuracy, and therefore to correct tire models for each road surface characteristic with high accuracy.

The correction processing unit 107 may correct the tire model stored in the model storage unit 106 at each predetermined timing using the tire characteristics identified by the tire characteristic identification unit 104. This makes it possible to correct the tire model in response to tire deterioration over time and tire replacement. As a result, it becomes possible to estimate the friction coefficient of the vehicle more accurately, taking into account tire deterioration over time and tire replacement. The predetermined timing may be at regular intervals or when a specific event occurs. The regular interval may be every time a fixed time elapses or every time a fixed distance is traveled.

The friction coefficient estimation unit 108 estimates the friction coefficient around the vehicle using the road surface characteristics identified by the road surface characteristic identification unit 102, the tire model stored in the model storage unit 106, and the tire characteristics identified by the tire characteristic identification unit 104. According to the above configuration, the friction coefficient is estimated using the road surface characteristics identified based on the environment information, the tire characteristics, and the tire model, so that the friction coefficient can be estimated according to the road surface characteristics and the tire characteristics. Furthermore, the tire characteristics are determined based on the detection results of at least one of the vehicle motion sensor 12 and the tire sensor 13, so it becomes possible to estimate the friction coefficient according to the tire characteristics of the tire of each individual vehicle. As a result, it becomes possible to estimate the coefficient of friction of vehicle with higher accuracy even when there are differences in the tires of individual vehicle. The processing in the friction coefficient estimation unit 108 corresponds to a friction coefficient estimation step.

The friction coefficient estimation unit 108 may estimate the friction coefficient around the vehicle based on the road surface characteristics identified by the road surface characteristic identification unit 102 and the tire model corrected by the correction processing unit 107. The tire model corrected by the correction processing unit 107 is corrected using the tire characteristics identified by the tire characteristic identification unit 104, and therefore reflects the tire characteristics according to the tires of each vehicle. Therefore, with the above configuration, it is possible to estimate the friction coefficient according to the tire characteristics of each tire of the vehicle based on the road surface characteristics and the tire model, without having to identify the tire characteristics of the vehicle one by one. Therefore, it is possible to estimate the friction coefficient according to the tire characteristics of the tires of each vehicle while suppressing the processing load of identifying the tire characteristics of the vehicle one by one.

The braking identification unit 109 determines the effectiveness of braking of the vehicle based on the detection results of the vehicle motion sensor 12. The effectiveness of braking can be described as the effectiveness of the brake pedal. The effectiveness of braking may be determined, for example, by a ratio of deceleration to the amount of brake operation. The effectiveness of braking may be determined, for example, by a ratio of deceleration to the amount of brake actuation. As an example of the effectiveness of the braking of the vehicle, for example, the braking stiffness of the vehicle may be used. It is preferable that the braking identification unit 109 uses the detection results of the vehicle motion sensor 12, which are used to identify the tire characteristics in the tire characteristic identification unit 104, to identify the effectiveness of braking. For example, the amount of brake operation detected by a brake pedal position sensor, the amount of brake drive detected by a brake ECU, and the deceleration detected by an acceleration sensor may be used. According to the above configuration, it becomes possible to specify the effectiveness of braking with less effort. Furthermore, the results of identifying the effectiveness of braking can be used for driving control.

The cornering identification unit 110 determines the effectiveness of steering of the vehicle based on the detection results of the vehicle motion sensor 12. As an example of the effectiveness of steering, the cornering stiffness of the vehicle may be used. The cornering stiffness is a ratio of increase in cornering force when the tire's sideslip angle is very small. The cornering stiffness may be, for example, a ratio of increase in cornering force when the tire has a sideslip angle of 0 degrees. The cornering stiffness may be determined, for example, by a ratio of the yaw rate to the steering operation amount. The cornering identification unit 110 preferably uses the detection results of the vehicle motion sensor 12, which are used to identify the tire characteristics in the tire characteristic identification unit 104, also to identify the effectiveness of the steering. As an example, the steering angle detected by a steering angle sensor and the yaw rate detected by a yaw rate sensor may be used. According to the above configuration, it is possible to identify the effectiveness of steering of the vehicle with less effort. In addition, the results of identifying the effectiveness of steering can be used for driving control.

The tire abnormality determination unit 111 determines whether there is an abnormality in the tire of the vehicle based on the detection results of the vehicle motion sensor 12. The tire abnormality may be a drop in air pressure and wear. The tire abnormality may be determined, for example, when the degree of deviation between the predicted behavior in response to operation and the actual behavior is equal to or greater than a threshold value. For example, the tire abnormality may be determined based on the degree of turning being significantly smaller than predicted in response to steering operation. Alternatively, the tire abnormality may be determined based on the degree of deceleration being significantly smaller than expected in response to braking operation. The threshold value may be set arbitrarily. The tire abnormality determination unit 111 preferably uses the detection results of the vehicle motion sensor 12, which are used for identifying the tire characteristics in the tire characteristic identification unit 104, also for tire abnormality determination. According to the above configuration, it becomes possible to identify the tire abnormality with less effort. Furthermore, the results of identifying tire abnormality can be used for driving control and information presentation.

The control instruction unit 112 changes the state of driving control of the vehicle. The control instruction unit 112 may change the state of driving control of the vehicle by sending an instruction to the vehicle control ECU 15. The control instruction unit 112 corresponds to a control change unit.

It is preferable that the control instruction unit 112 changes the state of driving control of the vehicle in accordance with the friction coefficient estimated by the friction coefficient estimation unit 108 and the effectiveness of braking identified by the braking identification unit 109. This makes it possible to control the traveling of the vehicle in a way that is suited to the coefficient of friction around the vehicle and the effectiveness of braking of the vehicle. An example of changing the state of driving control in accordance with the friction coefficient estimated by the friction coefficient estimation unit 108 may be as follows. When the friction coefficient is smaller than a specified value, the vehicle speed may be limited, acceleration may be suppressed, or the vehicle may be decelerated. An example of changing the state of the driving control in accordance with the effectiveness of braking identified by the braking identification unit 109 may be as follows. When the effectiveness of braking is less than a specified value, the vehicle speed may be limited. When the braking stiffness is used as an indicator of the effectiveness of braking, the following procedure can be used. For example, the parameters of the vehicle stabilization control using the braking stiffness may be changed according to the identified braking stiffness.

It is preferable that the control instruction unit 112 changes the state of driving control of the vehicle according to the friction coefficient estimated by the friction coefficient estimation unit 108 and the effectiveness of steering identified by the cornering identification unit 110. This makes it possible to control the traveling of the vehicle in a way that is suited to the coefficient of friction around the vehicle and the effectiveness of steering of the vehicle. The state of the driving control may be changed in accordance with the friction coefficient estimated by the friction coefficient estimation unit 108 as described above. An example of changing the state of driving control in accordance with the effectiveness of steering identified by the cornering identification unit 110 may be as follows. When the cornering stiffness is used as an indicator of the effectiveness of steering, the following procedure can be used. For example, the parameters of the vehicle stabilization control using the cornering stiffness may be changed according to the identified cornering stiffness.

It is preferable that the control instruction unit 112 changes the state of driving control of the vehicle in accordance with the friction coefficient estimated by the friction coefficient estimation unit 108 and the result of the abnormality determination by the tire abnormality determination unit 111. This enables the driving control of the vehicle to be adapted to the coefficient of friction around the vehicle and the result of the abnormality determination in the tire of the vehicle. The state of the driving control may be changed in accordance with the friction coefficient estimated by the friction coefficient estimation unit 108. An example of changing the state of driving control in accordance with the abnormality determination result by the tire abnormality determination unit 111 may be as follows. For example, when it is determined that there is a tire abnormality, the vehicle speed may be limited, acceleration may be suppressed, or the vehicle may be decelerated.

The HCU communication unit 113 executes a process of outputting information to the HCU 18 and a process of acquiring information from the HCU 18. The HCU communication unit 113 acquires information input by the user via the user input device 17. As an example, when the HCU communication unit 113 receives information input to specify the type of tire of the vehicle, the following may be done. For example, the friction coefficient estimation unit 108 may switch the tire model used for estimation to a tire model corresponding to the specified type based on this information. When the input specifying the type of tire is received by the user input device 17, the tire characteristic identification unit 104 may be configured not to specify the type of tire as tire characteristics.

The HCU communication unit 113 includes a presentation processing unit 1131 as a sub-functional block. The presentation processing unit 1131 indirectly controls the presentation of information on the presentation device 16. That is, the presentation processing unit 1131 presents information to the user of the vehicle. The presentation processing unit 1131 corresponds to a presentation instruction unit.

The presentation processing unit 1131 preferably presents information according to the friction coefficient estimated by the friction coefficient estimation unit 108 and the result of abnormality determination by the tire abnormality determination unit 111. This makes it possible to present information that is tailored to the friction coefficient around the vehicle and the abnormality determination results regarding the tire of the vehicle. An example of presenting information according to the friction coefficient estimated by the friction coefficient estimation unit 108 is as follows. When the friction coefficient is smaller than a specified value, for example, information may be presented to warn the driver that the vehicle is slipping. An example of information presentation according to the result of abnormality determination by the tire abnormality determination unit 111 may be as follows. When it is determined that there is a tire abnormality, information indicating that there is a tire abnormality may be presented.

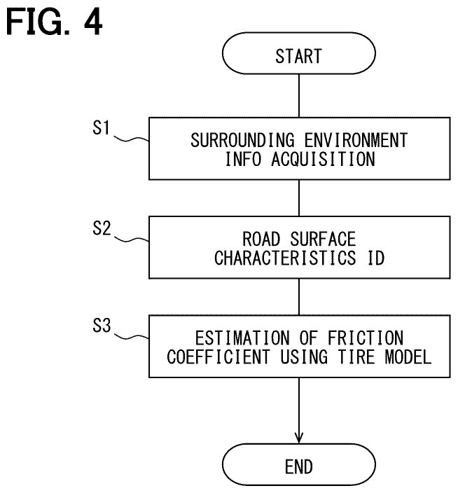

An example of flow of processing related to the estimation of the friction coefficient in the friction coefficient estimation device 10 (hereinafter, referred to as estimation processing) will be described with reference to the flowchart of FIG. 4. The flowchart of FIG. 4 may be started at regular intervals, for example, when the power switch of the vehicle is turned on. The regular interval may be set arbitrarily. The power switch is used to start the internal combustion engine or motor generator of the vehicle. In FIG. 4, the friction coefficient ahead of the path of the vehicle is estimated. In FIG. 4, a tire model is stored in advance in the model storage unit 106.

In step S1, the friction coefficient estimation device 10 acquires various data, which includes the surrounding environment information acquired by the environment information acquisition unit 101 from the communication module 11 and the monitoring sensor 14. In step S2, the road surface characteristic identification unit 102 identifies the road surface characteristics ahead of the vehicle based on the environment information acquired by the environment information acquisition unit 101.

In step S3, the friction coefficient ahead of the path of the vehicle is estimated based on the road surface characteristics identified in S2 and the tire model stored in the model storage unit 106, and the estimation processing is terminated. The estimated friction coefficient may be used to change the driving control and provide information as described above.

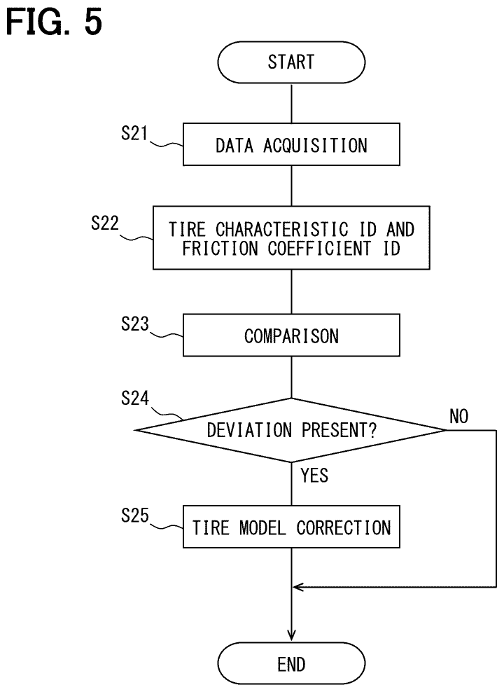

Next, an example of flow of processing related to correction of the tire model in the friction coefficient estimation device 10 (hereinafter, correction processing) will be described with reference to the flowchart of FIG. 5. The flowchart of FIG. 5 may be started, for example, when the power switch of the vehicle is turned on, at a cycle longer than the cycle of the estimation processing.

In step S21, the friction coefficient estimation device 10 acquires various data, which includes sensing information acquired by the motion information acquisition unit 103 from the vehicle motion sensor 12. This data includes sensing information that the tire characteristic identification unit 104 acquires from the tire sensor 13.

In step S22, the tire characteristic identification unit 104 identifies the current tire characteristics from the sensing information acquired from the tire sensor 13 and the sensing information acquired by the motion information acquisition unit 103. Furthermore, the friction coefficient identification unit 105 determines the friction coefficient at the current position from the sensing information acquired by the motion information acquisition unit 103.

In step S23, the friction coefficient determined in S22 is compared with the friction coefficient at the current position estimated in the estimation processing. The friction coefficient at the current position estimated in the estimation processing (hereinafter referred to as the estimated friction coefficient) can be determined from the time series data of the friction coefficient ahead in the path of the vehicle estimated in the estimation processing and the distance traveled by the vehicle. The travel distance of the vehicle may be determined from the vehicle speed and the time elapsed since the coefficient of friction ahead in the path of the vehicle is estimated.

In step S24, when the friction coefficient determined in S22 and the friction coefficient at the current position estimated in the estimation processing deviate by more than the threshold value (YES in S24), the process proceeds to step S25. When there is no deviation equal to or greater than the threshold (NO in S24), the correction processing ends.

In step S25, the correction processing unit 107 corrects the tire model stored in the model storage unit 106, and the correction processing ends. As a specific example, a correction may be made to update the friction coefficient of the tire model corresponding to the tire characteristics identified in S22 and the road surface characteristics used to estimate the estimated friction coefficient to the friction coefficient identified in S22.

After the tire model is corrected in the correction processing, the estimation processing is performed using the corrected model. This makes it possible to more accurately estimate the friction coefficient ahead along the path of the vehicle in the estimation processing, taking into account tire deterioration over time and tire replacement.

### Second Embodiment

The friction coefficient may be estimated using the tire characteristics identified by the tire characteristic identification unit 104 in a configuration other than that described in the first embodiment (hereinafter, referred to as the second embodiment). For example, this may be executed in a following manner. The model storage unit 106 is assumed to previously store tire models in which friction coefficients are associated with each combination of road surface characteristics and tire characteristics. In the second embodiment, the road surface characteristics are sequentially identified by the road surface characteristic identification unit 102. In the second embodiment, the tire characteristics are sequentially identified by the tire characteristic identification unit 104. The friction coefficient estimation unit 108 estimates, as the friction coefficient, the friction coefficient associated with the identified road surface characteristics and tire characteristics in the tire model stored in the model storage unit 106.

In the second embodiment, the friction coefficient is estimated using the road surface characteristics identified based on the environment information, the tire characteristics identified based on the detection results of at least one of the vehicle motion sensor 12 and the tire sensor 13, and the tire model. Therefore, it becomes possible to estimate the friction coefficient according to the tire characteristics related to the tires of individual vehicle. As a result, it becomes possible to estimate the coefficient of friction of the vehicle with higher accuracy even when there are differences in the tires of individual vehicles.

### Third Embodiment

In the above embodiment, the control instruction unit 112 is responsible for changing the state of driving control of the vehicle, but not necessarily limited to this. For example, the function of changing the state of the driving control of the vehicle may be performed by an ECU other than the friction coefficient estimation device 10. Furthermore, the function of presenting information is performed by the presentation processing unit 1131 in the above embodiment, but not necessarily limited to this. For example, the function of presenting information may be performed by an ECU other than the friction coefficient estimation device 10.

In this disclosure or claims, the term “processor” refers to a single or multiple hardware processors configured to execute the processing specified by computer program code (i.e., one or more instructions of the computer program) contained in a computer program by reading the code each time. In other words, a “processor” is a hardware device that executes one or more programmed processes. Therefore, the computer program code can also be referred to as software capable of defining the processing of the processor in accordance with the content thereof. For example, a “processor” may be a general-purpose or special-purpose processor, such as, but not limited to, a CPU, a microprocessor, a GPU, and a DFP (Data Flow Processor).

In this disclosure or claims, the term “memory” refers to one or more hardware memories that are non-transitory tangible storage media configured to store computer program code and/or data accessible to a processor. A “memory” may be implemented with memory technologies such as SRAM, SDRAM, non-volatile/flash type memory, or other types of memory. The computer program code constituting the program can be stored in a memory and executed by a processor to cause the processor to realize the various functions described above.

In this disclosure or claims, the term “circuit” refers to a logic circuit as a single piece or a plurality of pieces of hardware, and is configured to execute specific processing defined based on a pre-designed circuit configuration. In other words, (and in contrast to “processor”), the “circuit” in the present disclosure refers to a hardware device that executes specific processing based on a circuit configuration, rather than processing defined by software such as the above-mentioned computer program code. For instance, “circuit” may include a custom IC (Integrated Circuit) such as ASIC (Application Specific Integrated Circuit) or FPGA (Field Programmable Gate Array) designed using a hardware description language (HDL). That is, the “circuit” in the present disclosure includes all hardware circuits except for the above-mentioned processor that executes processing by reading computer program code.

In this disclosure or claims, the phrase “at least one of a processor and a circuit” should be interpreted disjunctively (logical OR), and not as at least one processor and at least one circuit. Thus, in this disclosure or claims, “at least one of a processor and a circuit” includes the case where only the circuit performs all functions. Also, in this disclosure or claims, “at least one of a processor and a circuit” includes the case where only the processor performs all functions. In this disclosure or claims, “at least one of a processor and a circuit” includes the case where the circuit performs some functions and the processor performs the remaining functions.

What is claimed is:

1. A friction coefficient estimation device for a vehicle, comprising: at least one of (i) a circuit and (ii) a processor with a memory storing computer program code executable by the processor, the at least one of the circuit and the processor configured to cause the friction coefficient estimation device to:
acquire environment information about an environment of the vehicle;
identify tire characteristic of a tire of the vehicle based on a detection result of at least one of (i) a vehicle motion sensor to detect states related to behavior or operation correlated with a tire force of the vehicle, or (ii) a tire sensor to monitor the tire of the vehicle;
identify road surface characteristics of a road surface around the vehicle based on the environment information;
store a tire model that outputs a friction coefficient between the road surface and the tire according to a combination of the road surface characteristics and the tire characteristic; and
estimate the friction coefficient, around the vehicle, using the tire characteristic, the road surface characteristics and the tire model.

2. The friction coefficient estimation device according to claim 1, wherein the at least one of the circuit and the processor is configured to cause the friction coefficient estimation device to:
correct the tire model using the tire characteristic to provide a corrected tire model.

3. The friction coefficient estimation device according to claim 2, wherein the at least one of the circuit and the processor is configured to cause the friction coefficient estimation device to:
estimate the friction coefficient, around the vehicle, using the road surface characteristics and the corrected tire model.

4. The friction coefficient estimation device according to claim 2, wherein the at least one of the circuit and the processor is configured to cause the friction coefficient estimation device to:
correct the tire model based on the tire characteristic for each of the road surface characteristics.

5. The friction coefficient estimation device according to claim 1, wherein the at least one of the circuit and the processor is configured to cause the friction coefficient estimation device to:
identify the tire characteristic based on at least a detection result of the vehicle motion sensor,
identify an effectiveness of braking of the vehicle based on the detection result of the vehicle motion sensor, and
use the detection result of the vehicle motion sensor to identify the tire characteristic and the effectiveness of braking.

6. The friction coefficient estimation device according to claim 5, wherein the at least one of the circuit and the processor is configured to cause the friction coefficient estimation device to:
change a state of driving control of the vehicle, depending on the friction coefficient and the effectiveness of braking.

7. The friction coefficient estimation device according to claim 1, wherein the at least one of the circuit and the processor is configured to cause the friction coefficient estimation device to:
identify the tire characteristic based on at least a detection result of the vehicle motion sensor,
identify an effectiveness of steering of the vehicle based on the detection result of the vehicle motion sensor, and
use the detection result of the vehicle motion sensor to identify the tire characteristic and the effectiveness of steering.

8. The friction coefficient estimation device according to claim 7, wherein the at least one of the circuit and the processor is configured to cause the friction coefficient estimation device to:
change a state of driving control of the vehicle, depending on the friction coefficient and the effectiveness of steering.

9. The friction coefficient estimation device according to claim 1, wherein the at least one of the circuit and the processor is configured to cause the friction coefficient estimation device to:
identify the tire characteristic based on at least a detection result of the vehicle motion sensor,
determine an abnormality in the tire of the vehicle based on the detection result of the vehicle motion sensor, and
use the detection result of the vehicle motion sensor to identify the tire characteristic and to determine whether there is an abnormality in the tire.

10. The friction coefficient estimation device according to claim 9, wherein the at least one of the circuit and the processor is configured to cause the friction coefficient estimation device to:
present information to a user of the vehicle, depending on the friction coefficient and a result of determination whether there is the abnormality in the tire.

11. The friction coefficient estimation device according to claim 9, wherein the at least one of the circuit and the processor is configured to cause the friction coefficient estimation device to:
change a state of driving control of the vehicle, depending on the friction coefficient and a result of determination whether there is the abnormality in the tire.

12. A friction coefficient estimation method for a vehicle to be executed by at least one of a processor and a circuit, comprising:
acquiring environment information about an environment of the vehicle;
identifying tire characteristic of a tire of the vehicle based on a detection result of at least one of (i) a vehicle motion sensor to detect states related to behavior or operation correlated with a tire force of the vehicle and (ii) a tire sensor to monitor the tire of the vehicle;
identifying road surface characteristic of a road surface around the vehicle based on the environment information; and
estimating a friction coefficient between the road surface and the tire, around the vehicle, using the tire characteristic, the road surface characteristic and a tire model held in a model storage unit to output the friction coefficient according to a combination of the road surface characteristic and the tire characteristic.
